(19) United States
(12) Patent Application Publication
(10) Pub. No.: US 2026/0274602 A1
(43) Pub. Date: Sep. 17, 2026

(54) SUPPORT APPARATUS FOR HOLDING FILMS BY ELECTROADHESIVE FORCE AND METHOD

(71) Applicant: KRONES AG, Neutraubling (DE)

(72) Inventors: Fabian GOTZLER, Regensburg (DE); Martin KUPKA, Landau (DE); Andreas HACK, Osterhofen (DE)

(21) Appl. No.: 19/565,200

(22) Filed: Mar. 12, 2026

(30) Foreign Application Priority Data
Mar. 12, 2025 (DE) 102025109458.6

(51) Int. Cl. B65H 16/00; B65C 9/18

(52) U.S. Cl. CPC B65H 16/005; B65C 9/1869; B65H 2405/58; B65H 2553/20; B65H 2701/192; B65H 2801/75

(57) ABSTRACT

A support apparatus for holding a film, in particular a label film, having a planar support portion on which a portion of the film can be applied, wherein the support portion is configured to hold this portion by a predetermined holding force, and wherein this support portion extends in a longitudinal direction and a width direction perpendicular to the longitudinal direction. The support portion is configured to hold the portion of the film at least temporarily by an electroadhesive force.

### CROSS REFERENCE TO RELATED APPLICATION

This application claims benefit to German Patent Application Serial No. 10 2025 109 458.6, filed Mar. 12, 2025, the contents of which are incorporated herein by reference.

### BACKGROUND OF THE INVENTION

The present invention relates to a support apparatus for holding a film or a portion of film. Such support apparatuses can be used, for example, in labeling machines. The present invention is therefore also described with reference to a labeling machine, but it is pointed out that the apparatus according to the invention can also be used in other fields, in particular in the beverage-producing industry.

In a holding apparatus known from the applicant's prior art, a vacuum strip is provided, i.e., the holding force is generated by a negative pressure or a vacuum. In this case, a label film is laid onto and held on a suction strip on a vacuum support via a roller until it is used. An operator cuts off the label, applies a double-sided adhesive tape, and places the label in the correct position on the vacuum strip so that it can then be joined to the production web by automatic bonding. The suitably cut end of a new label roll is placed on the suction strip and then vacuum-held until the roll's turn comes and it is adhesively attached by the bonding carriage to the end of the depleted old roll.

The entire vacuum strip is always in use, regardless of the label height to be processed. In this label strip, several small bores connect a central distribution bore or distribution line to the vertical openings in the strip. Smaller angled bores increase the suction surface.

The same technique is used in different labeling applications, such as vertical alignment and horizontal alignment.

JP H 09 226 734 A discloses an apparatus for electrostatic charging of cut labels. In this case, a full film web is statically charged after cutting and thus adheres briefly to a holding roller.

An apparatus for attaching labels is known from EP 0 031 383 A1. In this process, a label is statically charged. GB 2 306 437 A also describes a method for attaching a label to a bottle. An electric field is also used to at least temporarily attach an edge of the label to a substrate.

U.S. Pat. No. 3,508,993 also describes a method for attaching plastic material labels to containers. An electrical charge is applied to the container. U.S. Pat. No. 3,726,520 describes a method for transporting films using electrostatic adsorption.

The vacuum strips described have certain disadvantages. As long as a label is being held, the vacuum must be maintained, which is why a vacuum pump (usually a Venturi vacuum pump) or the like is in continuous operation. With smaller labels, only a few suction holes are active, which is why the holding force decreases and the energy demand increases due to additional ambient air.

Furthermore, this suction strip holds the film only at discrete points and is therefore inactive between the suction surfaces. If the suction is too high, the film is locally drawn in and may be damaged. If such a vacuum suction strip is deactivated after the label has been removed or processed further, it must be manually switched on again before reloading, or the label must be manually applied.

Furthermore, the vacuum pump generates considerable noise and also requires complex wiring, as the suction strips must be switched on and off independently of one another.

The electrostatic charging described above has the disadvantage that the static charge loses its effect over time, as it dissipates through the air or other components. In addition, a comparatively large installation space is required, since cylindrical geometries are provided.

Furthermore, such arrangements do not allow for alignment or simple placement of the film.

Since, furthermore, the film leading end is currently intended to be gripped by a vacuum gripper for up to six hours or more, the region in question must also be accessible.

The present invention is therefore based on the object of providing a holding device or support apparatus for films that is easier to operate and that can also dispense with vacuum generation.

### SUMMARY OF THE INVENTION

A support apparatus according to the invention for holding a film and, in particular, a label film has a (in particular planar) support portion on which a portion of the film can be applied, wherein the support portion is suitable and intended to hold this film portion by a predetermined holding force. Preferably, this support portion extends in a longitudinal direction and in a width direction perpendicular to the longitudinal direction.

According to the invention, the support portion is suitable and intended to hold the portion of the film at least temporarily by an electroadhesive force. It is therefore proposed to use an electroadhesive holding force instead of a vacuum holding force or an electrostatic holding force.

In a further preferred embodiment, the support portion has a planar surface. Particularly preferably, the support portion has a rectangular shape.

By using an electroadhesive force, noise can be reduced on the one hand, and a reliable holding force can be provided on the other hand. The main advantage, however, is that compressed air can be saved compared to the conventional vacuum method.

In a further preferred embodiment, the support portion is suitable and intended to hold an initial portion of the film and, in particular, to hold it by the aforementioned electroadhesive force.

The support portion is particularly preferably configured as a support strip. Preferably, the support portion extends further in the longitudinal direction than in the width direction. Preferably, the support portion extends at least twice as far in the longitudinal direction as in the width direction, preferably at least three times as far.

In a preferred embodiment, the support portion can be subjected to an electrical voltage in order to cause the film to adhere to the support portion. For this purpose, the support portion preferably has at least one electrode.

In a further advantageous embodiment, the support portion is arranged on a bracket and, in particular, attached to this bracket. It is conceivable that the bracket has a recess into which the support portion can be inserted. In addition, holding portions can also be provided on the bracket, which ensure that the support portion is held in place on the bracket.

For example, the bracket can have a dovetail profile into which a corresponding counter-profile of the support portion engages. Particularly preferably, the support portion is removeable from the bracket. In a further preferred embodiment, the support portion can be inserted or slid into the bracket in a longitudinal direction of the support portion.

However, other types of attachment are also possible, in particular, but not exclusively, screw connections and quick-change systems.

Preferably, a voltage source, and in particular a DC voltage source, is provided for applying the electrical voltage to the support portion, which voltage source can be connected to the at least one electrode of the support portion. Preferably, the applied voltages are greater than 500 V, preferably greater than 700 V, preferably greater than 900 V, preferably greater than 1000 V and particularly preferably greater than 1500 V.

Preferably these voltages are less than 15000 V, preferably less than 12000 V, preferably less than 10000 V, preferably less than 8000 V, preferably less than 6000 V.

Electroadhesion is the effect whereby two surfaces subjected to an electric field adhere to one another. This electroadhesion has recently found various applications.

Electroadhesion utilizes electrostatic charging. A particular advantage is that this effect can also be easily reversed, for example by reversing a voltage.

In a further advantageous embodiment, the support portion has a first electrode, which is arranged in particular on a surface of the support pointing in the direction of the film to be held. Preferably, this electrode extends in different directions.

An electrical voltage can preferably be applied to this first electrode.

Preferably, the electrode consists of a material selected from a group of materials containing copper, iron or aluminum.

In a further advantageous embodiment, the support portion has a second electrode, which is arranged in particular on the surface of the support portion pointing in the direction of the film to be held. A voltage can preferably be applied to this second electrode.

In a further preferred embodiment, a dielectrically acting substance, i.e., a dielectric, is arranged on the support portion, wherein this dielectric is preferably arranged on the surface of the support portion facing in the direction of the film to be held. The dielectric is preferably a solid. Preferably, this dielectric is smooth on the surface of the support portion. This can be achieved, for example, by post-processing the dielectric after it has been applied to the support portion.

Preferably, the dielectric is arranged at least in portions and particularly preferably completely between the electrodes (preferably as is also the case with a capacitor).

Particularly preferably, this dielectric consists of a material selected from a group of materials that includes elastomers, glass, quartz, mica, polyethylene, polymethyl methacrylate, polystyrene, polyisobutylene, polyvinyl chloride, porcelain or oil.

Particularly preferably, the dielectric embeds one electrode and preferably both electrodes. Preferably, the electrodes therefore do not form an outer surface of the support portion, but particularly preferably the dielectric.

Particularly preferably, a surface of the support portion on which the at least one electrode is arranged consists of an electrically insulating material.

In a further preferred embodiment, at least one electrode has a conductor portion extending in a first direction and a plurality of second conductor portions branching off from this first conductor portion.

Particularly preferably, the aforementioned second conductor portions extend perpendicular to the first direction and/or the first conductor portion.

Preferably, the second conductor portions each have the same spacing from one another (in particular with respect to the first direction). However, it would also be conceivable for the spacing between the second conductor portions to decrease or increase in a certain direction, such as the longitudinal direction of the support portion.

In a further preferred embodiment, the support apparatus has a deflection roller for deflecting the film.

Particularly preferably, this deflection roller is rotatable with respect to an axis of rotation that extends parallel to the support portion and, in particular, parallel to the longitudinal direction of the support portion.

The deflection roller is particularly preferably spaced apart from the support portion in a transport direction of the film. Particularly preferably, the spacing is greater than 1 cm, preferably greater than 2 cm, particularly preferably greater than 3 cm. Preferably, this spacing is less than 30 cm, preferably less than 25 cm, preferably less than 20 cm and preferably less than 15 cm.

Preferably, the deflection roller is positioned such that a film deflected by the deflection roller is aligned parallel to the support portion in the direction of the support portion. Preferably, the deflection roller is positioned such that a film deflected by the deflection roller is aligned in the direction of the support portion such that the spacing between the film and the surface of the support portion is less than 3 cm, preferably less than 2 cm, preferably less than 1.5 cm, preferably less than 1.0 cm and particularly preferably less than 0.5 cm.

In a further preferred embodiment, the apparatus has a measuring device that is suitable and intended for measuring an electrical energy absorbed by the support portion. Alternatively or additionally, a measuring device can also be provided that is suitable and intended for measuring an electric field and/or a change in the electric field. This measurement can be used to determine whether and, if so, how a label is currently being held electroadhesively. This measurement can also be used to determine the height of the label.

The present invention further relates to an apparatus for treating containers and in particular to an apparatus for labeling containers, i.e., a labeling machine, which has at least one film support of the type described above.

The present invention is further directed to the use of a support apparatus that is suitable and intended for holding a film and, in particular, a label film by electroadhesive forces for an apparatus for labeling containers. Preferably, the support apparatus is configured in the manner described above.

The present invention is further directed to a support portion and, in particular, a support strip for holding films, in particular plastic material films and in particular labels or label films, which extends in a longitudinal direction and a width direction perpendicular to this longitudinal direction, having at least one first electrode that is arranged on a surface of the support portion facing in the direction of the film to be held, and having at least one dielectric that is arranged on the surface of the support portion facing the film to be held, wherein preferably the first electrode is embedded in the dielectric such that an outer surface of the support portion (and in particular an outer surface that serves to hold the film) is formed exclusively by the dielectric, and wherein at least one electrical connection is provided to connect the first electrode to a voltage source.

Preferably, the support portion has at least one fastening element that allows the support portion to be attached to a bracket. Particularly preferably, the support portion is configured in the manner described above.

Preferably, a second electrode is provided and/or the support portion has a second electrode. Preferably, the dielectric is arranged at least in portions and preferably completely between the first electrode and the second electrode.

The present invention is further directed to methods for holding a film, in particular a label film, by a support apparatus that has a support portion, in particular a planar support portion, against which a portion of the film is placed. Furthermore, this support portion holds this portion of the film in place by a predetermined holding force.

According to the invention, the support portion holds the portion of the film at least temporarily with or by an electroadhesive force.

Particularly preferably, a voltage is applied to the support portion and, in particular, to at least one electrode of the support spacing, which voltage serves to build up the electroadhesive force.

In a further preferred method, the voltage applied to the at least one electrode is changed at least temporarily and preferably reversed. Particularly preferably, a DC voltage is applied at least temporarily to the at least one electrode.

### BRIEF DESCRIPTION OF THE DRAWINGS

Further advantages and embodiments can be seen in the accompanying drawings:

In the drawings:

FIG. 1 shows a support apparatus according to the prior art;

FIG. 2 shows a detailed view of the support apparatus according to FIG. 1;

FIG. 3 shows a representation of a support apparatus according to the invention;

FIG. 4 shows a representation of a support portion of a support apparatus according to the invention;

FIG. 5 shows a further view of a support portion in a first embodiment;

FIG. 6 shows a support portion for retrofitting to a support apparatus;

FIG. 7 shows a further embodiment of a support portion;

FIG. 8 shows a further embodiment of a support portion;

FIG. 9 shows a further embodiment of a support portion; and

FIG. 10 shows a further embodiment of a support portion.

### DETAILED DESCRIPTION OF THE INVENTION

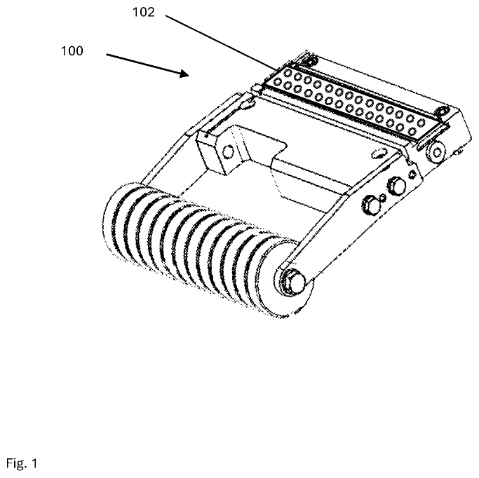

FIG. 1 shows a support apparatus 100 according to the prior art for holding a film (not shown). The reference sign 102 refers to a support portion that serves to hold the film by a vacuum. In this case, across the overall length of the support portion 102, the entire strip is always active, regardless of which label height is to be processed.

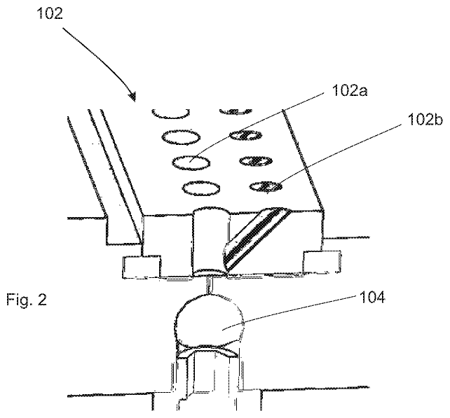

As shown in FIG. 2, several small bores 102a are provided, which establish a connection with a horizontal bore 104. In addition, smaller angled bores 102b are provided, which increase the suction surface.

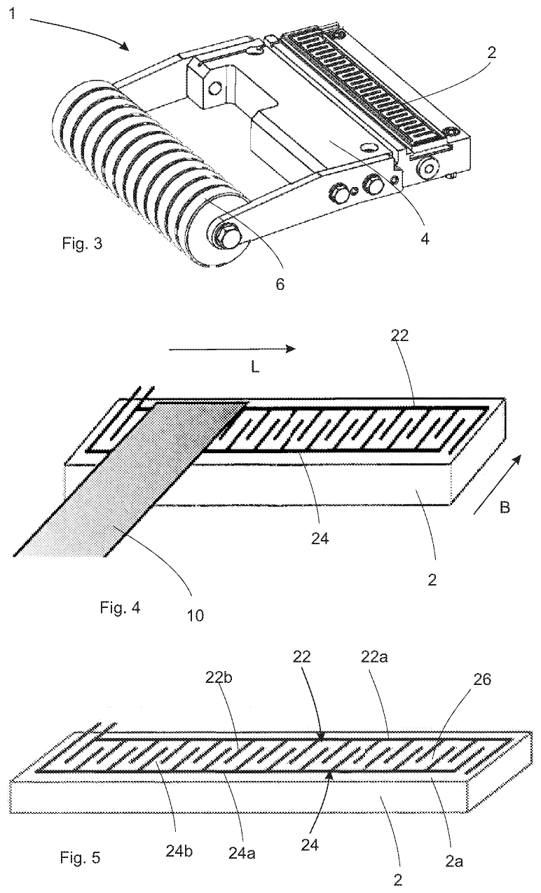

FIG. 3 shows a support apparatus 1 according to the invention. Said support apparatus has a deflection roller 6 for deflecting a label (not shown), as well as a support portion 2 that is arranged on a bracket 4, in the case of FIG. 3 a dovetail guide.

FIG. 4 shows a support portion or support part 2 with a film 10 arranged or held thereon. The reference sign 22 designates a first electrode, and the reference sign 24 designates a second electrode. Both are arranged on the surface 2a of the support portion and on the surface facing the film 10. It is evident that this surface is flat.

The reference sign L designates a longitudinal direction of the support portion or support strip, and the reference sign B designates a width direction of the support portion or support strip.

FIG. 5 also shows the support portion or support part or support strip. In addition to the electrodes 22 and 24, a dielectric 26 is provided. In this case, the electrodes 22 and 24 are applied on the surface of the support portion and are coated with this dielectric 26. The electric field acting between the electrodes and the film holds the film to the support strip as long as a sufficiently high voltage is applied to the electrodes.

A DC voltage source (not shown) is therefore preferably provided to supply the electrodes with an electrical voltage. Preferably, a control device is also provided, which is intended for controlling this voltage. For example, the voltage can be reversed to detach the film from the support portion.

The invention thus offers a simple solution for both new installations and for retrofitting existing installations. Since only a minimal current is required at the moment the electric field is built up, the power consumption is limited to a few watts and the holding strip or support portion can remain permanently switched on. The holding force remains constant and is hardly dependent on time.

The approach proposed here does not negatively affect the weight or the installation space. In addition, the complexity of the wiring is reduced because all of the support portions or support strips can remain active permanently. The risk of injury or electric shock is eliminated because the electroadhesion pad is insulated to the outside.

No mechanical force is applied, so the label remains undamaged. With the proper configuration, the label film can be peeled off and repositioned by the operator as many times as necessary without losing its holding force.

For new installations, hoses, distribution manifolds and vacuum generators can be dispensed with. However, particularly preferably, a high-voltage transformer is provided in addition to the support portion. This also eliminates any noise pollution.

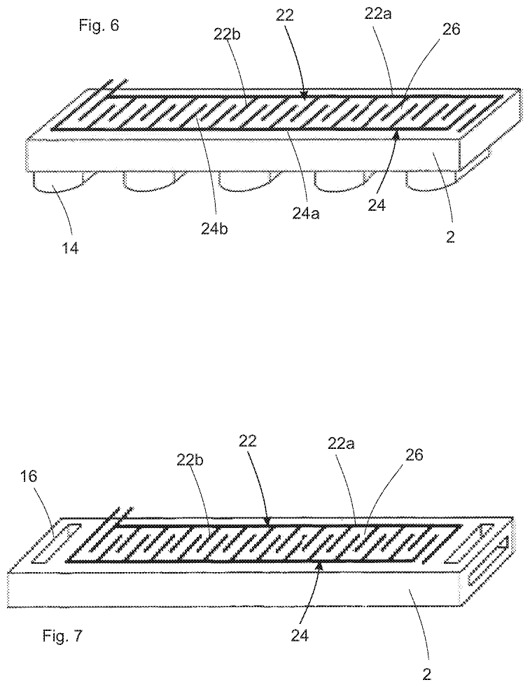

FIG. 6 shows a further embodiment of a support apparatus according to the invention. Said support portion has elements 14 that act as fitting elements so that the support portion can be integrated into existing installations.

FIG. 7 shows a further embodiment of a support portion 2. For vertical or horizontal mounting (in particular on new installations), a cutout 16 is provided for easy clamping and good replaceability.

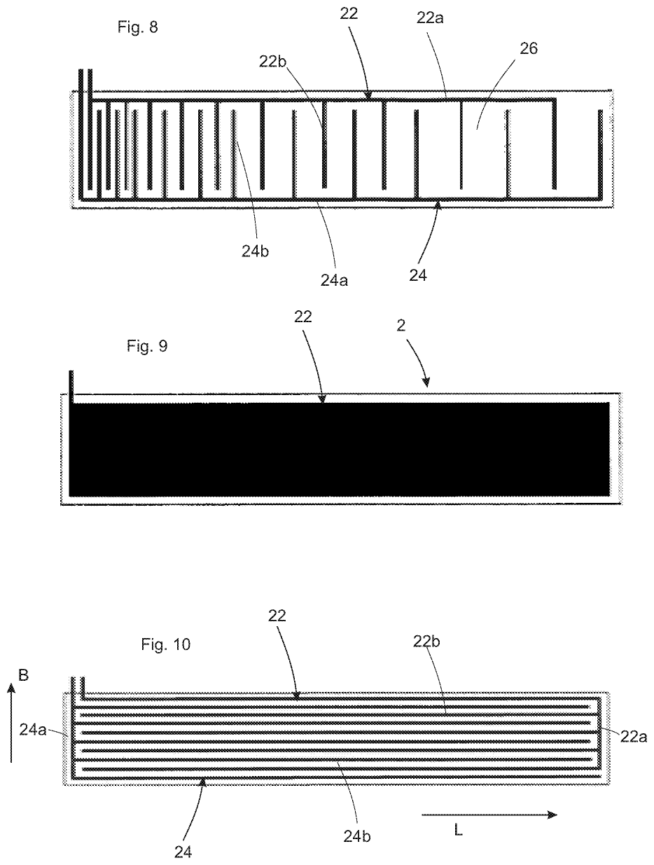

FIG. 8 shows a further example of a support portion. Here too, two electrodes 22 and 24 are provided. These have a longitudinally extending portion 22a and a plurality of portions 22b perpendicular thereto. Accordingly, the electrode 24 also has a longitudinally extending portion 24a and a plurality of portions 24b, which preferably extend perpendicular to the longitudinal direction and/or in the width direction.

In the embodiment shown in FIG. 8, the electrodes were adapted to the required holding voltage both for narrow and wide labels. This is achieved by the increasing distances between electrode portions 22b and 24b from left to right.

In the variant shown in FIG. 9, only one electrode 22 is provided in order to achieve greater adhesive forces at the same voltage.

FIG. 10 shows a further embodiment of a support portion, which here forms a direction-independent holding force through a parallel electrode design. In this case, the first portions 22a and 24a extend in the width direction of the support portion, and the second portions 22b and 24b extend in the length direction of the support portion.

It is pointed out that all features which have been described with reference to the method are also correspondingly disclosed for the apparatus, which means in particular that the corresponding apparatus comprises devices which are suitable and intended for carrying out the particular methods. Further, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is further pointed out that features which can be advantageous in themselves are also described in the individual figures. A person skilled in the art will immediately recognize that a particular feature described in a figure can be advantageous even without the incorporation of further features from this figure. Furthermore, a person skilled in the art will recognize that advantages can also result from a combination of several features shown in individual or in different figures.

1. A support apparatus for holding a film, having a planar support portion on which a portion of the film can be applied, wherein the support portion is configured to hold this portion by a predetermined holding force, and wherein this support portion extends in a longitudinal direction and a width direction perpendicular to the longitudinal direction,
wherein
the support portion is configured to hold the portion of the film at least temporarily by an electroadhesive force.

2. The support apparatus according to claim 1,
wherein
the support portion is configured to be applied with an electrical voltage in order to cause the film to be held in place on the support portion.

3. The support apparatus according to claim 1,
wherein
the support portion is arranged on a bracket.

4. The support apparatus according to claim 1,
wherein
the support portion has a first electrode.

5. The support apparatus according to claim 4,
wherein
the support portion has a second electrode.

6. The support apparatus according to claim 5,
wherein
a dielectric is arranged on the support portion and/or between the electrodes.

7. The support apparatus according to claim 5,
wherein
at least one electrode has a first conductor portion extending in a first direction and a plurality of second conductor portions branching off from this first conductor portion.

8. The support apparatus according to claim 1,
wherein
the support apparatus has a deflection roller configured for deflecting the film.

9. The support apparatus according to claim 1,
wherein
the support apparatus has a measuring device that is configured for measuring an electrical energy absorbed by the support portion and/or that is configured for measuring an electric field and/or a change in the electric field.

10. A support portion for holding films, which extends in a longitudinal direction and a width direction perpendicular to this longitudinal direction, having at least one first electrode that is arranged on a surface of the support portion facing in the direction of the film to be held, and having at least one dielectric that is arranged on the surface of the support portion facing the film to be held, wherein the first electrode is embedded in the dielectric such that an outer surface of the support portion is formed exclusively by the dielectric, and wherein at least one electrical connection is provided to connect the first electrode to a voltage source.

11. An apparatus for treating containers with a film support according to claim 1.

12. The apparatus according to claim 11,
wherein
the apparatus has a voltage source.

13. A method for holding a film by a support apparatus that has a planar support portion on which a portion of the film is applied, wherein the support portion holds this portion by a predetermined holding force,
wherein
the support portion holds the portion of the film at least temporarily by an electroadhesive force.
